(19) United States
(12) Patent Application Publication
(10) Pub. No.: US 2011/0060850 A1
(43) Pub. Date: Mar. 10, 2011

(54) MOBILE DEVICE OF SUPPORTING UART AND USB COMMUNICATION USING SAME CONNECTOR AND OPERATING METHOD THERE-OF

(75) Inventors: Jae in Ko, Seoul (KR); Shin ho Moon, Seoul (KR); Yong tae Park, Uijeongbu-si (KR)

(73) Assignee: BLUEBIRD SOFT CO., LTD., Seoul (KR)

(21) Appl. No.: 12/863,390

(22) PCT Filed: Jan. 15, 2009
(86) PCT No.: PCT/KR09/00221

§ 371 Date: Jul. 16, 2010

(30) Foreign Application Priority Data
Jan. 17, 2008 (KR) 10-2008-0005427

(51) Int. Cl. G06F 3/00; G06F 13/42

(52) U.S. Cl. 710/15; 710/106

(57) ABSTRACT

A mobile device for supporting universal asynchronous receiver/transmitter (UART) communication and universal serial bus (USB) communication using a single connector and a method thereof are provided. The mobile device includes a USB connector, a USB module selectively connected with the connector to communicate with an external USB device, at least one internal UART device selectively connected with the connector to communicate with an external UART device, a determiner configured to determine whether the connector has been coupled to the external USB device or the external UART device based on a signal applied to at least one of pins of the connector, a switching unit configured to selectively connect data lines of the connector to one among the USB module and the at least one internal UART module based on a determination result of the determiner, and a central processing unit (CPU) configured to control the switching unit, thereby automatically switching the data lines of the connector to an appropriate internal module according to whether a device coupled to the connector is a USB device or a UART device.

### TECHNICAL FIELD

The present invention relates to a mobile device, and more particularly, to a circuit for supporting universal asynchronous receiver/transmitter (UART) and universal serial bus (USB) communication using a single connector and a mobile device including the same.

### BACKGROUND ART

Mobile devices usually include one or more connectors for interface with external devices and support communication using those connectors. Serial communication, universal asynchronous receiver/transmitter (UART) communication, and universal serial bus (USB) communication are usually used for interface between mobile devices and external devices.

When the more communication modes are supported by mobile devices, additional connectors suitable for the communication modes need to be provided, resulting in the increase in size and cost of mobile devices. Therefore, a technique for supporting different communication modes using a single connector is desired to prevent the size and the cost of mobile devices from increasing.

### DETAILED DESCRIPTION OF THE INVENTION

### Technical Goal of the Invention

The present invention provides a mobile device for supporting universal asynchronous receiver/transmitter (UART) communication and universal serial bus (USB) communication using a single connector.

The present invention also provides a mobile device for identifying a USB device coupled to a connector and automatically switching the path of the connector.

### Effect of the Invention

According to the present invention, a mobile device can be coupled and communicate with both a USB device and a UART device through a single USB connector. Accordingly, the mobile device does not need to include separate connectors for different communication modes supported by the mobile device, so that the size and the cost of the mobile device are reduced.

In addition, since whether an external device coupled to the USB connector is a USB device is detected and data lines of the connector are automatically switched to either an internal USB module or an internal UART module, user convenience is increased.

### BRIEF DESCRIPTION OF THE DRAWINGS

The brief description of the drawing is provided for sufficient understanding of the attached drawings referred to in the detailed description of the present invention:

FIG. 1 is a block diagram of a mobile device according to some embodiments of the present invention;

FIG. 2 is a diagram of the structure of a switching unit illustrated in FIG. 1;

FIG. 3 is a diagram of the structure of a universal serial bus (USB) signal detector illustrated in FIG. 1; and

FIG. 4 is a flowchart of a method of automatically switching the path of a universal serial bus (USB) connector of a mobile device according to some embodiments of the present invention.

### BEST MODE FOR CARRYING OUT THE INVENTION

According to an aspect of the present invention, there is provided a mobile device including a universal serial bus (USB) connector, a USB module selectively connected with the connector to communicate with an external USB device, at least one internal universal asynchronous receiver/transmitter (UART) device selectively connected with the connector to communicate with an external UART device, a determiner configured to determine whether the connector has been coupled to the external USB device or the external UART device based on a signal applied to at least one of pins of the connector, a switching unit configured to selectively connect data lines of the connector to one among the USB module and the at least one internal UART module based on a determination result of the determiner, and a central processing unit (CPU) configured to control the switching unit.

The connector includes a power supply voltage pin, a first data pin and a second data pin for data transmission, and a ground pin, and the data lines of the connector are respectively connected with the first data pin and the second data pin.

The determiner determines that the connector has been coupled to the external USB device when the second data pin is a predetermined logic level and a voltage applied to the power supply voltage pin is at least a predetermined level.

According to another aspect of the present invention, there is provided a method of operating a mobile device. The method includes driving data line of a USB connector to a high-impedance state in a system disable state; detecting a signal applied to the USB connector and determining whether a device coupled to the connector is a USB device; and selectively connecting the data lines of the connector to one module among an internal USB module and at least one internal UART module, which are included in the mobile device, based on the determination result in a system enable state.

The connector includes a power supply voltage pin, a first data pin and a second data pin for data transmission, and a ground pin, and the determining whether the device is the USB device comprises determining that the connector has been coupled to the USB device when the second data pin is a predetermined logic level and a voltage applied to the power supply voltage pin is at least a predetermined level.

### EMBODIMENTS

The attached drawings for illustrating preferred embodiments of the present invention are referred to in order to gain a sufficient understanding of the present invention, the merits thereof, and the objectives accomplished by the implementation of the present invention. Hereinafter, the present invention will be described in detail by explaining preferred embodiments of the invention with reference to the attached drawings. Like reference numerals in the drawings denote like elements.

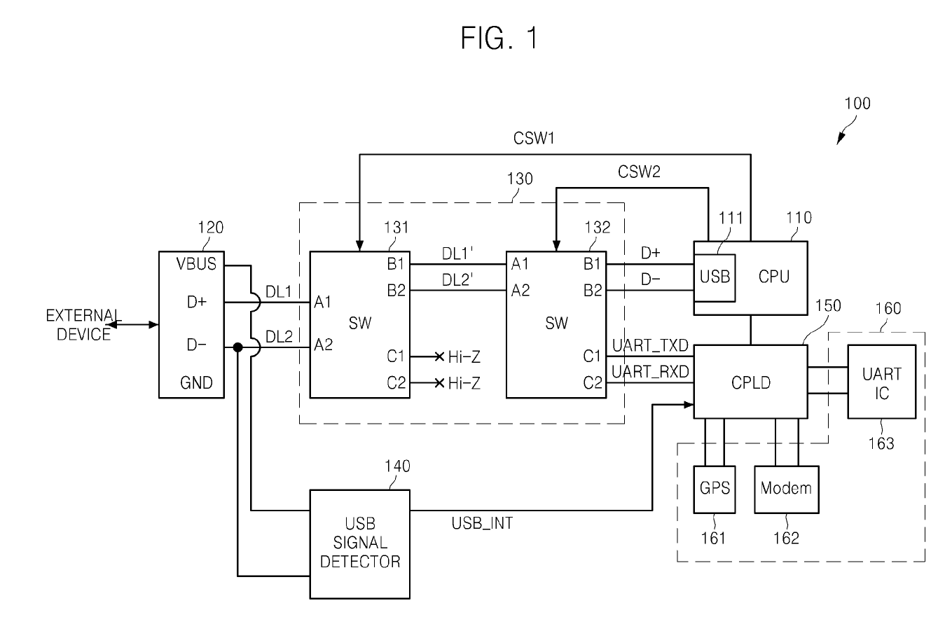

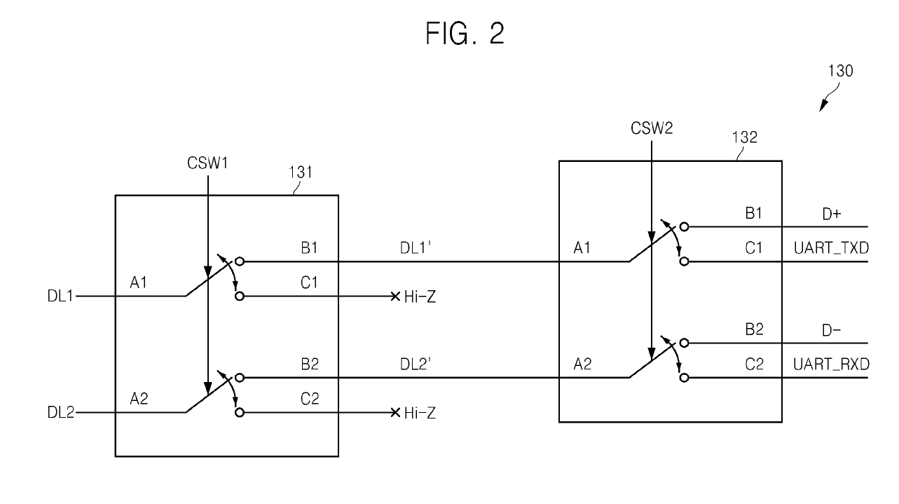

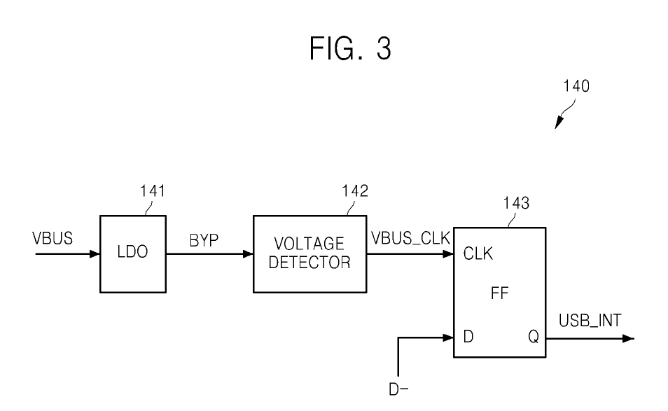

FIG. 1 is a block diagram of a mobile device 100 according to some embodiments of the present invention. FIG. 2 is a diagram of the structure of a switching unit 130 illustrated in FIG. 1. FIG. 3 is a diagram of the structure of a universal serial bus (USB) signal detector 140 illustrated in FIG. 1.

Referring to FIGS. 1 through 3, the mobile device 100 includes a central processing unit (CPU) 110, a connector 120, the switching unit 130, a determiner (140 and 150), a USB module 111, and a universal asynchronous receiver/transmitter (UART) unit 160. Although not shown, the mobile device 100 may also include a display module, a speaker and microphone module, a memory, a Bluetooth module, a battery module, and an antenna.

The CPU 110 executes a program and/or firmware for the operation of the mobile device 100 and generates a control signal for controlling the operation of each module or element included within the mobile device 100. In the current embodiments of the present invention, the USB module 111 is provided within the CPU 110, but the present invention is not restricted to the current embodiments.

The connector 120 is used to couple the mobile device 100 to an external device (e.g., a personal computer (PC) or an adaptor) through a cable (not shown) and includes at least four pins. One end of the cable is coupled to the connector 120 and another end of the cable is coupled to a connector of the external device. Of the four pins of the connector 120, one may be for a power supply voltage VBUS, two others may be for transmission of data D+ and D−, and the other may be for a ground GND. When the connector 120 includes at least five pins, all but four pins may not be used in a no connect (NC) state. For instance, the connector 120 may be a 5- or 9-pin USB connector. The switching unit 130 selectively connects the data lines DL1 and DL2 of the connector 120 to the USB module 111 or at least one of elements included in the UART unit 160. For instance, the switching unit 130 may controlled by the CPU 110 to automatically switch the path of the connector 120.

Referring to FIG. 2, the switching unit 130 includes a first switch 131 and a second switch 132.

The first switch 131 connects the data lines DL1 and DL2 of the connector 120 to the second switch 132 or drives the data lines DL1 and DL2 to a high-impedance state Hi-Z in response to a first switch control signal CSW1 generated by the CPU 110. For instance, when the first switch control signal CSW1 is set to a first logic level (e.g., “1”), the first switch 131 connects the data lines DL1 and DL2 to the second switch 132. When the first switch control signal CSW1 is set to a second logic level (e.g., “0”), the first switch 131 drives the data lines DL1 and DL2 to the high-impedance state Hi-Z.

The first switch control signal CSW1 may be set differently according to the state of the CPU 110 or the mobile device 100. For instance, the first switch control signal CSW1 may be set to logic “1” while the mobile device 100 is powered on with a battery installed and to logic “0” while the battery is removed from the mobile device 100 or the power of the mobile device 100 is turned off. In another instance, the first switch control signal CSW1 may be set to logic “1” while the CPU 110 is in a wake-up, standby or sleep state and to logic “0” while the CPU 110 is in a deep-sleep state.

The system states in which the first switch control signal CSW1 is set to logic “1” may be defined as system enable states and the system states in which the first switch control signal CSW1 is set to logic “0” may be defined as system disable state. A system enable signal may be output from the CPU 110 to indicate a system enable or disable state. The system enable signal is set to, for example, a first logic level “1” in a system enable state. Accordingly, the first switch control signal CSW1 may be set to logic “1” when the system enable signal is at logic “1” and to logic “0” when the system enable signal is at logic “0”.

In a system disable state, the USB operation of the CPU 110 is unstable, which may cause errors. The first switch 131 drives the data lines DL1 and DL2 to the high-impedance state Hi-Z when the CPU 110 is in a predetermined state (e.g., a deep-sleep state), thereby preventing errors that may occur when the connector 120 is connected to USB terminals D+ and D− of the CPU 110 in the system disable state.

The second switch 132 connects data lines DL1′ and DL2′ of the first switch 131 to the USB terminals D+ and D− of the CPU 110 or to a complex programmable logic device (CPLD) 150 in response to a second switch control signal CSW2 generated by the CPU 110. For instance, when the second switch control signal CSW2 is set to a first logic level (e.g., “1”), the second switch 132 connects the data lines DL1′ and DL2′ to the USB terminals D+ and D− of the CPU 110. When the second switch control signal CSW2 is set to a second logic level (e.g., “0”), the second switch 132 connects the data lines DL1′ and DL2′ to UART terminals UART_TXD and UART_RXD of the CPLD 150.

The determiner (140 and 150) determines whether an external device coupled to the connector 120 is a USB device or a UART device based on a signal VBUS, D+, D−, or GND applied to at least one of the pins of the connector 120. For this operation, the determiner includes the USB signal detector 140 and the CPLD 150.

The USB signal detector 140 detects whether an external device coupled to the connector 120 is a USB device based on the level of the power supply voltage VBUS applied to a power supply voltage pin of the connector 120 and the signal D− applied to a second data pin of the connector 120 and generates a USB detection signal USB_INT.

An example of the structure of the USB signal detector 140 is illustrated in FIG. 3. Referring to FIG. 3, the USB signal detector 140 includes a low-dropout (LDO) regulator 141, a voltage detector 142, and a flip-flop 143.

The LDO regulator 141 is connected with the power supply voltage pin of the connector 120 and generates a predetermined output voltage BYP when a voltage within a predetermined range is applied to the power supply voltage pin of the connector 120. For instance, the LDO regulator 141 includes an input terminal connected with the power supply voltage pin of the connector 120 and an output terminal outputting the output voltage BYP. When the voltage VBUS applied to the input terminal is at least a predetermined voltage (e.g., 3 V), the LDO regulator 141 may output the predetermined output voltage BYP (e.g., 3 V). In other words, the LDO regulator 141 may output the output voltage BYP of 3 V when the power supply voltage VBUS is at least 3 V.

The LDO regulator 141 may be implemented separately outside a charge integrated circuit (IC) (not shown) or may be implemented within the charge IC. The charge IC is a circuit for charging a battery of a mobile device and supplying system power to an internal system of the mobile device.

The voltage detector 142 includes an internal delay circuit and delays and outputs the output voltage BYP of the LDO regulator 141. Since a cable for the connection of an external device may not be properly coupled to the connector 120 at once when a user try to couple the cable to the connector 120, delay time is set in the voltage detector 142 to provide a temporal margin until the cable is satisfactorily stably coupled to the connector 120.

An output signal VBUS_CLK of the voltage detector 142 is input to a clock terminal CLK of the flip-flop 143 and the signal D− of the second data pin of the connector 120 is input to an input terminal D of the flip-flop 143. The flip-flop 143 may be a D-Q flip-flop.

The flip-flop 143 latches the signal D− input to the input terminal D at a rising edge of the output signal VBUS_CLK of the voltage detector 142 to output the USB detection signal USB_INT.

When an external USB device is coupled to the connector 120, the power supply voltage VBUS has a predetermined voltage level (e.g., 5 V) and the signal D− of the second data pin is maintained at a predetermined logic level (e.g., a logic low) for a predetermined period of time and then changes to be complementary to the signal D+ of a first data pin of the connector 120 according to transmitted data.

Accordingly, when an external USB device is coupled to the connector 120, the signal D− of the second data pin is at the logic low at a rising edge of the output signal VBUS_CLK of the voltage detector 142. Therefore, the USB detection signal USB_INT output from the flip-flop 143 is also at a logic low.

When a different external device other than USB devices is coupled to the connector 120, an operation is performed so that a signal input to the input terminal D of the flip-flop 143 is at a logic high at a rising edge of the output signal VBUS_CLK of the voltage detector 142. For this operation, although not shown in FIG. 3, the output terminal of the LDO regulator 141 may be connected via a resistor (not shown) to the input terminal D of the flip-flop 143. In other words, the input terminal D of the flip-flop 143 may be connected with both the output terminal of the LDO regulator 141 via the resistor and the second data pin of the connector 120.

Accordingly, when an external USB device is coupled to the connector 120, the USB detection signal USB_INT is output at the logic low by the signal D− of the second data pin. When a UART device other than USB devices is coupled to the connector 120, the USB detection signal USB_INT is output at the logic high.

The CPLD 150 generates and outputs an alarm signal to the CPU 110 based on the USB detection signal USB_INT and the system enable signal generated by the CPU 110. The USB detection signal USB_INT may also input to the CPU 110. The CPU 110 may generate the second switch control signal CSW2 based on the system enable signal, the USB detection signal USB_INT, and the alarm signal from the CPLD 150. For instance, when the USB detection signal USB_INT is at the logic low, the CPU 110 may determine that a device coupled to the connector 120 is a USB device and thus set the second switch control signal CSW2 so that the second switch 132 connects the data lines DL1′ and DL2′ to the USB module 111.

Contrarily, when the USB detection signal USB_INT is at the logic high, the CPU 110 determines that a device coupled to the connector 120 is a UART device and thus set the second switch control signal CSW2 so that the second switch 132 connects the data lines DL1′ and DL2′ to the CPLD 150.

The CPLD 150 selectively connects a data line to one of a plurality of modules using UART communication in compliance with the CPU 110. In the current embodiments of the present invention, the CPLD 150 is controlled by the CPU 110 to selectively connect the data line to one module among a UART IC 163, a global positioning system (GPS) module 161, and a communication modem 162. Which one of the UART IC 163, the GPS module 161, and the communication modem 162 is connected to the data line may be controlled by the CPU 110 according to setting by a user.

The communication modem 162 may support code division multiple access (CDMA) communication and/or global system for mobile communications (GSM) communication. The communication modem 162 may be connected with an external UART device using UART communication to download firmware.

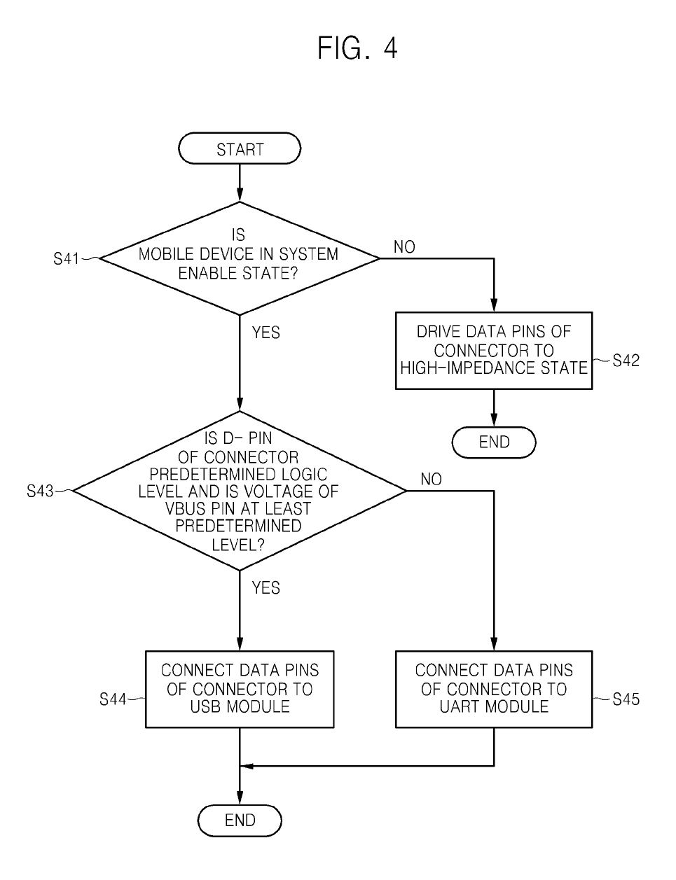

FIG. 4 is a flowchart of a method of operating the mobile device 100 according to some embodiments of the present invention. Referring to FIGS. 1 through 4, it is determined whether the mobile device 100 is in a system enable state in operation S41. When the mobile device 100 is not in the system enable state, that is, the mobile device 100 is in a system disable state, the data pins of the connector 120 are driven to the high-impedance state Hi-Z in operation S42 to prevent the occurrence of errors.

When the mobile device 100 is in the system enable state, a signal applied to the connector 120 is detected to determine whether a device coupled to the connector 120 is a USB device in operation S43. In detail, when a signal at the D− pin of the connector 120 is at a predetermined logic level (e.g., “0”) and a voltage at the VBUS pin of the connector 120 is at least a predetermined level, it is determined that the device coupled to the connector 120 is a USB device in operation S43. When the device coupled to the connector 120 is determined to be a USB device, the data pins of the connector 120 are connected to the USB module 111 in operation S44. When the device coupled to the connector 120 is determined not to be a USB device, the data pins of the connector 120 are connected to one of the UART modules 161, 162, and 163 in operation S45.

As described above, according to the present invention, a mobile device can be coupled and communicate with both a USB device and a UART device through a single USB connector. Accordingly, the mobile device does not need to include separate connectors for different communication modes supported by the mobile device. In addition, since whether an external device coupled to the USB connector is a USB device is detected and data lines of the connector are automatically switched to either an internal USB module or an internal UART module, different types of external devices are conveniently coupled to the single USB connector and used when necessary.

While the present invention has been particularly shown and described with reference to exemplary embodiments thereof, it will be understood by those of ordinary skill in the art that various changes in forms and details may be made therein without departing from the spirit and scope of the present invention as defined by the following claims.

### INDUSTRIAL APPLICABILITY

The present invention can be applied to mobile devices and reduce the size and the manufacturing cost of the mobile devices.

1. A mobile device comprising:
a universal serial bus (USB) connector;
a USB module selectively connected with the connector to communicate with an external USB device;
at least one internal universal asynchronous receiver/transmitter (UART) device selectively connected with the connector to communicate with an external UART device;
a determiner configured to determine whether the connector has been coupled to the external USB device or the external UART device based on a signal applied to at least one of pins of the connector;
a switching unit configured to selectively connect data lines of the connector to one among the USB module and the at least one internal UART module based on a determination result of the determiner; and
a central processing unit (CPU) configured to control the switching unit.

2. The mobile device of claim 1, wherein the connector comprises a power supply voltage pin, a first data pin and a second data pin for data transmission, and a ground pin; and the data lines of the connector are respectively connected with the first data pin and the second data pin.

3. The mobile device of claim 2, wherein the determiner determines that the connector has been coupled to the external USB device when the second data pin is a predetermined logic level and a voltage applied to the power supply voltage pin is at least a predetermined level.

4. The mobile device of claim 2, wherein the determiner comprises:
a USB signal detector configured to detect whether an external device coupled to the connector is a USB device based on a power supply voltage applied to the power supply voltage pin of the connector and a signal applied to the second data pin and to generate a USB detection signal; and
a programmable logic device configured to generate and output an alarm signal to the CPU based on the USB detection signal and a system enable signal generated by the CPU,
wherein the CPU generates a control signal for controlling the switching unit based on at least one signal among the system enable signal, the USB detection signal, and the alarm signal.

5. The mobile device of claim 4, wherein the USB signal detector comprises:
a regulator configured to generate an output voltage when the power supply voltage applied to the power supply voltage pin is within a predetermined range;
a voltage detector configured to delay and output the output voltage of the regulator; and
a flip-flop configured to latch and output the signal of the second data pin in response to a detection signal output from the voltage detector.

6. The mobile device of claim 4, wherein the switching unit comprises:
a first switch configured to operate in response to a first switch control signal; and
a second switch configured to selectively connect a data line of the first switch to one terminal between an input/output terminal of the USB module and an input/output terminal of the programmable logic device in response to a second switch control signal,
wherein the first switch selectively connects the data lines of the connector to the second switch or drives the data lines to a high impedance state in response to the first switch control signal and the programmable logic device is controlled by the CPU to connect a data line connected with the input/output terminal of the programmable logic device to one module among the at least internal UART module.

7. The mobile device of claim 6, wherein the first switch control signal is set to drive the data lines of the connector to the high-impedance state when the system enable signal is at a first logic level and is set to connect the data lines of the connector to the second switch when the system enable signal is at a second logic level.

8. The mobile device of claim 6, wherein the USB module is comprised within the CPU and the at least one internal UART module is at least one among a UART chip, a global positioning system (GPS) module, and a communication modem.

9. The mobile device of claim 8, wherein the CPU generates a path selection signal according to setting by a user and the programmable logic device selectively connects the data line connected with the input/output terminal of the programmable logic device to one among the UART chip, the GPS module, and the communication modem in response to the path selection signal.

10. A method of operating a mobile device, the method comprising:
driving data line of a universal serial bus (USB) connector to a high-impedance state in a system disable state;
detecting a signal applied to the USB connector and determining whether a device coupled to the connector is a USB device; and
selectively connecting the data lines of the connector to one module among an internal USB module and at least one internal universal asynchronous receiver/transmitter (UART) module, which are included in the mobile device, based on a determination result in a system enable state.

11. The method of claim 10, wherein the connector comprises a power supply voltage pin, a first data pin and a second data pin for data transmission, and a ground pin; and the determining whether the device is the USB device comprises determining that the connector has been coupled to the USB device when the second data pin is a predetermined logic level and a voltage applied to the power supply voltage pin is at least a predetermined level.
